(19) United States
(12) Patent Application Publication
(10) Pub. No.: US 2002/0192467 A1
(43) Pub. Date: Dec. 19, 2002

(54) Method for the manufacture of a sheet of reinforcing fibers and the product obtained thereby

(76) Inventors: Duane R. Secrist, Knoxville, TN (US); F. Michael Cretella, Harriman, TN (US)

Correspondence Address: PITTS AND BRITTIAN P C, P O BOX 51295, KNOXVILLE, TN, 37950-1295, US

(21) Appl. No.: 10/168,832

(22) PCT Filed: May 10, 2001
(86) PCT No.: PCT/US01/15090

(51) Int. Cl. D04G 1/00; B32B 31/00

(52) U.S. Cl. 428/365; 156/60

(57) ABSTRACT

A method is provided for manufacturing a reinforcing sheet containing at least one sheet made of a plurality of high tensile modulus fiber monofilaments (12). The sheet defines a first surface (13) and a second surface (15). A first scrim (18) is bonded to the first surface of the sheet and a second scrim (18′) is bonded to the second surface of the sheet.

### CROSS-REFERENCE TO RELATED APPLICATIONS

Provisional Application No. 60/203,687 filed May 11, 2000

### STATEMENT REGARDING FEDERALLY SPONSORED RESEARCH OR DEVELOPMENT

Not applicable

### TECHNICAL FIELD

This invention relates to methods for the manufacture of sheets of reinforcing fibers and to novel sheets produced by the method.

### BACKGROUND OF INVENTION

Fiber sheets containing predominantly reinforcing fibers are used in many applications. Commonly each such application calls for the laying up of multiple layers of the sheets, the sheets being bonded one to another, and/or to an underlying support, as by a matrix resin such as epoxy, vinylesters, phenolics, etc.

Carbon fiber sheets exhibit extraordinary tensile properties relative to their weight, but such are commonly directional. Moreover, carbon fiber sheets commonly are prepared with a resin embedded within the sheet, commonly referred to as “prepregs,” and require an interleaving or release paper between layers of the sheet on a roll, etc. to prevent the resin of one layer bonding with the resin of an adjacent layer on the roll or stack of sheets.

Reinforcing fibers of the prior art have included glass, carbon, aramid and other fibers, usually aligned in a common direction, e.g., in their machine direction. Various techniques have been employed to aid in imparting integrity to the sheet through consolidation of the reinforcing fibers into sheet form. These techniques include substantial or partial infusion of the fiber sheet by a resin material, adhesion of a cloth layer to one or both sides of the sheet, needling of yarns into the sheet, etc. The problems associated with such sheets of the prior art include (1) unacceptable addition of weight contributed to the overall weight of the sheet by the added material, such additional weight effectively defeating one of the major physical attributes of the carbon fiber sheet, namely, its low weight and superior tensile properties (2) increased cost for the production of the sheets, (3) decrease in the formability of the sheet about a mandrel, mold or the like, and/or (4) incompatibility between the material or substance employed to consolidate the fibers of the sheet and the matrix resin required to bond multiple layers of the sheets into a finished, e.g., laid up or molded, product.

### DESCRIPTION OF THE DRAWINGS

FIG. 1 is a schematic representation of a process and apparatus for carrying out the method of the present invention.

FIG. 2 is a schematic representation of an embodiment of a fiber sheet product including a scrim bonded to each of the opposite outer surfaces of the underlying fiber sheet and in which the yarns of the scrims are oriented substantially orthogonally with respect to the machine direction of the underlying fiber sheet.

FIG. 3 is a schematic representation of a further embodiment of a fiber sheet product including a scrim bonded to each of the opposite outer surfaces of the underlying fiber sheet wherein the yarns of the scrim are oriented at an angle which is not normal to the machine direction of the underlying sheet.

### SUMMARY OF INVENTION

In accordance with one aspect of the method of the present invention a scrim or the like comprising warp and weft yarns which intersect one another at an angle greater than zero and less than 180 degrees is overlaid and bonded to the opposite flat surfaces of a sheet of reinforcing fibers. In one embodiment, the warp and weft yarns intersect one another at 90 degree angles and the warp yarns are oriented with the machine direction of the reinforcing fibers of the sheet. In another embodiment, the warp yarns of the scrim are aligned at an angle of greater than zero and less than 90 degrees with respect to the machine direction of the sheet fibers, and the weft yarns are oriented at an angle of between greater than zero and less than 180 degrees with respect to the warp yarns. Other angular configurations of the warp and weft yarns will be obvious to one skilled in the art. In any event, either the warp or weft yarns of the scrim extend between the opposite edges of a fiber sheet such that the yarns overlie the fibers of the sheet in position to be bondable to the fibers of the sheet which are exposed on a flat surface of the sheet, thereby interbonding the fibers of the sheet, consolidating the reinforcing fibers into the desired sheet, and imparting integrity to the sheet. This “cross-sheet” bonding renders the sheet suitable for integration during layup or molding operations without loss of individual fibers from the sheet, but does not materially inhibit the conformability of the sheet.

The scrim contemplated by the present invention comprises yarns of various types, such as polyester or glass, for example. As desired, the scrim may comprise a combination of different types of yarns, such as polyester warp yarns and glass weft yarns, or vice versa. In accordance with one aspect of the present invention, each yarn carries thereon a thermoplastic binder agent which is suitable for bonding the warp and weft yarns of the scrim to one another at their points of intersection. This same binder agent is employed in the present invention to effect bonding of the scrim to the outer surfaces of the fiber sheet thereby minimizing the addition of weight to the fiber sheet through the use of (1) a gossamer net-like material for anchoring the reinforcing fibers of the sheet into an integrated and handleable sheet and (2) a thermoplastic binder agent which serves the dual purpose of bonding the warp and weft yarns of the scrim to one another and to also bond the scrim to the outer surfaces of the fiber sheet. These features are achievable through the use of a thermoplastic binder agent which permits the inexpensive production of the present scrim-bearing fiber sheet employing conventional hot-pressing equipment known in the industry.

The sheet of the present invention may comprise flattened tow(s) of continuous reinforcing fibers, a plurality of individual aligned fibers, or a laid sheet of chopped fibers. These fibers may comprise glass, aramid, carbon or other high modulus fibers. As desired, the fiber sheet may include gaps between portions of the fibers, e.g., porosity, sufficient to enhance the infusion of a matrix resin into the sheet during layup of the sheet into a molded product, for example. Alternatively, “wicking” yarns or filaments may be incorporated into the fiber sheet for like purposes.

In accordance with the present invention, at least two scrims are preferably overlaid and bonded to the opposite surfaces of the sheet. In one embodiment, such as when the yarns of the scrim are orthogonal and the warp yarns are oriented generally parallel to the machine direction of the fiber sheet, at least one warp yarn (and accompanying end portions of the weft yarns) are disposed laterally spaced from each of the opposite side edges of the fiber sheet such that when pressed together and heated, the laterally extending portions of the scrim on the bottom side of the sheet is bonded to the scrim on the top side of the sheet to thereby “lock” any loose fibers along each side of the sheet into the sheet itself. When employing a scrim in which the warp and weft yarns are both oriented at a substantial angle from the machine direction of the sheet, sufficient lengths of these yarns may be provided to extend beyond the side edges of the sheet such that the yarns of the bottom sheet contact the yarns of the top sheet and thereby may be bonded to one another at such contact locations to thereby lock in the fibers adjacent the side edges of the sheet. Alternatively, higher levels of binder resin may be included along an outer edge of the scrim-bearing fiber sheet for securing the outmost fibers of the sheet within the sheet. Other techniques for securing such outermost fibers may include the addition of a bonded tow along each edge or stitching of the edges.

In a preferred embodiment, the binding agent employed to interbond the yarns of the scrim is effective in preventing blocking of the adjacent layers of a rolled quantity of the scrim-faced sheet of carbon fibers. One suitable binding agent is a thermoplastic polyamide. This, and other suitable binding agents such as water soluble coatings, pressure sensitive adhesives, or the like, are capable of effecting bonding of the yarns of the scrim to one another and also capable of effecting bonding of the scrim to the underlying fiber sheet, employing heat and pressure. In a preferred embodiment the combination of the scrim and the binder agent carried on the scrim contribute minimally to the overall weight of the fiber sheet product.

The scrim-bearing fiber sheets of the present invention are readily handled during lay-up of a structure as is known in the art. They further are readily conformable to curved surfaces of a mandrel, preform, or other structure.

In accordance with another aspect of the present invention, there is provided a method for the production of a sheet of reinforcing fibers which exhibits minimal overall weight and maximal tensile properties.

### DETAILED DESCRIPTION OF THE INVENTION

With reference to the Figures, in which like reference numbers indicate like or corresponding features, there is depicted one embodiment of a process for carrying out the method of the present invention. A sheet 12 of carbon fibers comprising a plurality of unidirectional carbon fibers is fed forward to a treatment station 14. The sheet 12 includes a first surface 13 and an opposed second surface 15. The fibers of the carbon fiber sheet 12 are substantially aligned in the machine direction (M.D.) of the forward moving sheet 12. A sizing material selected from a group comprising epoxies, vinylesters, polyurethanes, phenolics, polyesters, and polyamides material may be applied to the fibers.

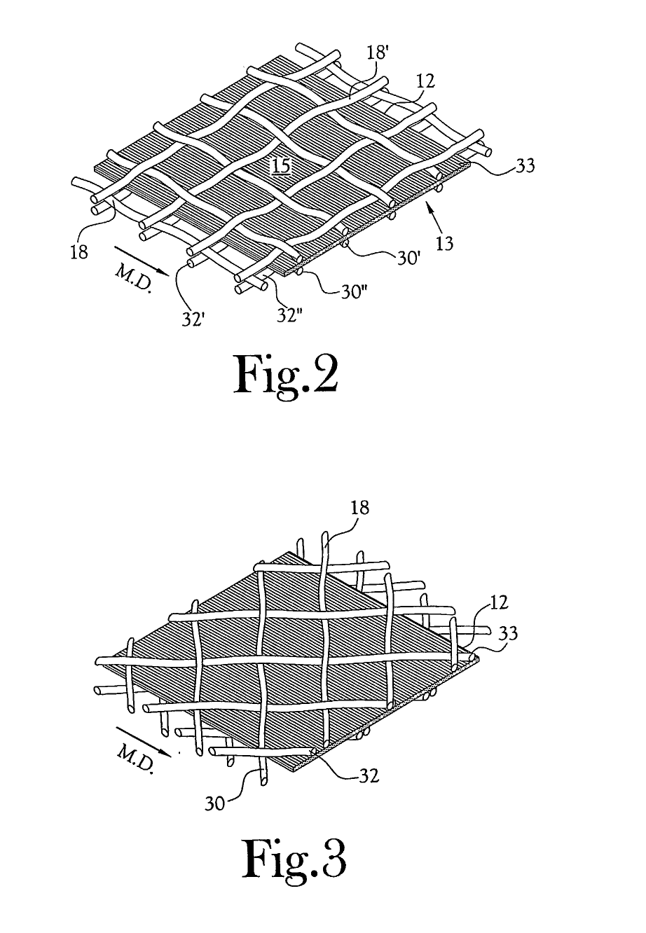

In advance of the treatment station, the first surface 13 of the carbon fiber sheet 12 is overlaid with a first scrim 18 comprising at least a plurality of yarns or strands that are oriented at least substantially normal to the machine direction of the carbon fiber sheet (See FIG. 2). The scrim 18 carries thereon a thermoplastic binding agent, such as a polyester, polyamide, polyethylene acrylic or other suitable thermoplastic resin. This binding agent serves initially to bind the yarns or strands of the scrim to one another to define the scrim 18. The second surface 15 of the carbon fiber sheet 12 is overlaid with a second scrim 18′ comprising at least a plurality of yarns or strands that are oriented at least substantially normal to the machine direction of the carbon fiber sheet. The scrim 18′ carries thereon a thermoplastic binding agent, such as a polyamide, polyethylene acrylic or other suitable thermoplastic resin. This binding agent serves initially to bind the yarns or strands of the scrim to one another to define the scrim 18′.

The carbon fiber sheet 12 and the overlaying scrims 18 and 18′ are thereafter fed forward through the treatment station 14 wherein the first and second scrims 18 and 18′ and the carbon fiber sheet are fed through the nip 22 of a pair of opposed heated steel nip rolls 24 and 26. The nip rolls 24 and 26 apply pressure against the carbon fiber sheet 12 and the scrims 18 and 18′ and heat the thermoplastic bonding agent on the scrims 18 and 18′ to at least its bonding temperature at the pressure generated by the nip rolls. By this means the thermoplastic binding agent is at least partially transferred to at least the first surface 13 and the second surface 15 of the carbon fiber sheet 12 at those locations wherein the yarns of the scrims 18 and 18′ engage the carbon fibers of the sheet 12. Those areas of the carbon fibers which are not engaged by a scrim yarn remain unbonded to one another. After the heated scrim-bearing sheet of carbon fibers 28 exits the nip rolls 24 and 26, optionally, it is fed forward through one or more further pairs of nip rolls (not depicted). Preferably, at least one of the rolls of each such pair of further nip rolls is a heated steel roll which serves to enhance the transfer of the thermoplastic bonding agent from the scrim and onto those locations where a yarn engages a fiber or fibers of the carbon fiber sheet 12. Following passage of the scrim-bearing carbon fiber sheet through the nip rolls, the sheet product 28 is cooled below the fusion temperature of the thermoplastic binding agent, e.g., to room temperature, whereupon the binding agent solidifies, bonding the scrims to their respective outer surfaces of the carbon fiber sheet. Thereafter, the sheet product is collected on a spool 30 or the like without use of an interleaving or release sheet between adjacent layers of the sheet product.

In one embodiment of the present invention, the scrims 18 and 18′ comprise polyester yarns which are bonded one to another by means of a thermoplastic binder. This binder is effective to bond the polyester yarns to the outer surfaces of the carbon fiber sheet 12 without the addition of additional binder being applied.

With reference to FIGS. 2 and 3, the scrims 18 and 18′ of the present invention preferably include both warp 30 and weft 32 yarns which are laid or woven using any of the known weave patterns, such as a square weave pattern (FIG. 2) in which the warp yarns are passed under and over alternating adjacent ones of the weft yarns and vice versa, as is well known in the weaving art. For purposes of the present description, those yarns of the scrim which are oriented generally parallel to the length of the carbon fibers 33 (M.D. of the sheet) of the carbon fiber sheet 12 are referred to as the warp yarns. This convention orients the weft yarns generally normal to the length of the carbon fibers. Whereas a scrim formed of both warp and weft yarns is preferred, it is the presence of the weft yarns of the scrim which are functionally critical to the present invention. Specifically, the primary function of the scrim in the present invention is to anchor and retain the carbon fibers of the carbon fiber sheet in their initial unidirectional alignment with one another, thereby establishing and retaining the desired unidirectional tensile properties of the carbon fiber sheet. Thus, in one embodiment, only “weft” yarns can be employed, but at an increased cost of equipment and processing cost associated with the laying down of yarns which are oriented normal to the machine direction (length direction) of the carbon fibers of the carbon sheet. As noted, preferably the “weft” yarns are included in a laid or woven scrim. It will be recognized, however, that the number of warp yarns per inch of the scrim is not particularly critical, and preferably the number of warp yarns per inch of the scrim is between one and four. Thus, the scrim of the present invention may be selected to be relatively gossamer and thereby contribute insignificantly to the overall weight of the composite scrim-bearing carbon fiber sheet product. Moreover, the fewer the number of yarns (both warp and weft) per inch of the scrim, the lesser the quantity of thermoplastic binder agent required, again reducing the contribution of the scrim to the overall weight of the product. This conservation of overall weight of the product, notably, is obtained while still enhancing the handling ability, flexural integrity and fixation of the carbon fibers of the carbon fiber sheet.

In order to promote wetout of the reinforcing sheets, wicking materials may be included with the fiber sheets. The wicking materials may comprise individual yarns or sheet materials, such as air laid glass veils, chopped strand mats, spun laid polyesters or chopped fiber carbon veils.

### EXAMPLE 1

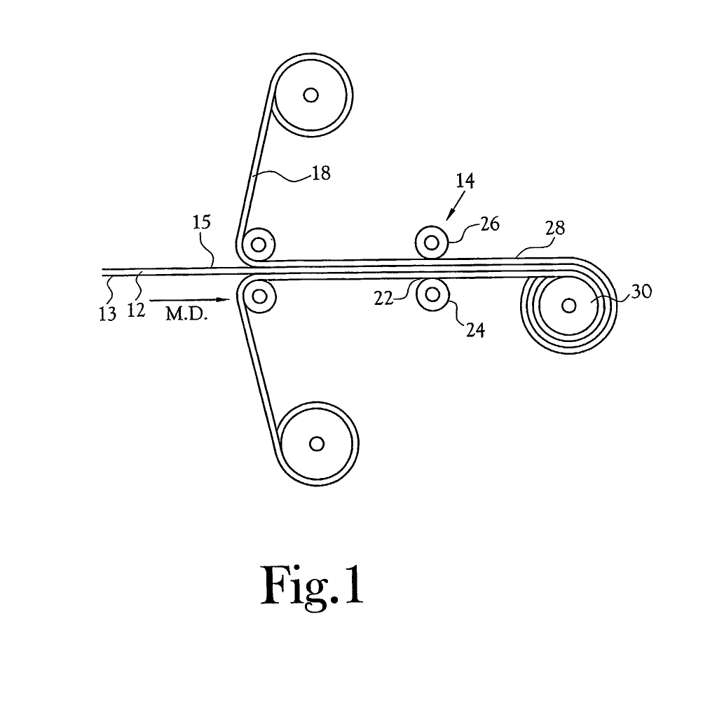

A woven scrim 18 of two polyester warp yarns 30′,30″ and two polyester weft yarns 32′,32″ per inch, and having a weight of about 5 gm/square meter is overlaid onto a first surface 13 of a carbon fiber sheet 12. (See FIG. 3). A second woven scrim 18′, similar to the woven scrim 18, is overlaid onto an opposed second surface 15 of the carbon fiber sheet 12. The widths of the scrims 18 and 18′ are greater than the width of the sheet 12, so that the scrims 18 and 18′ extend beyond the edges of the sheet 12. The yarns of each scrim were bonded one to another with a thermoplastic binder agent which had a bonding temperature of about 100° C. when pressed in the nip between heated steel nip rolls 24 and 26, each of a diameter of twelve inches, at a pressure of about 60 pounds. The carbon fibers 33 of the sheet 12 were continuous fibers having their respective lengths oriented with the machine direction of the sheet 12 as the sheet 12 was processed through the apparatus depicted in FIG. 1. The carbon fiber sheet 12 comprised a plurality of spread tows of individual carbon fibers and had a weight of 190 gm/square meter. The carbon fiber sheet 12 and the two overlaid scrim layers 18 and 18′ on the opposite sides of the sheet 12 were fed through the pair of heated steel nip rolls 24 and 26 at a maximum speed of about 30 ft/min. Each of the steel rolls 24 and 26 was heated to about 115° C. The bonded scrim-bearing sheet was collected on a take-up roll without the use of an interleaving or release sheet. No blocking of the rolled product was noted. In the product obtained, the scrim layers were well-bonded to the carbon fiber sheet, it was readily handleable during lay up procedures without disintegration of the fibrous sheet and was sufficiently flexible and strong as to be shaped about a mandrel, form or other structure. The thermoplastic binder in the scrim was fully compatible with the epoxy resin normally employed in lay up procedures.

In one lay up test, five layers of the scrim-bearing product described hereinabove were laid up in a mold with epoxy resin added between layers and the stack of layers was pressed in the mold for about 24 hours at room temperature. Upon release of the pressure in the mold, the product was examined for delamination. None was noted. Rather, the molded multi-layered product exhibited good interlayer bonding and good conformity to the mold geometry. In this example, the scrim and its binder agent contributed about 5% of the overall weight of the scrim-bearing fiber sheet.

In one manufacturing process, the scrim-bearing carbon fiber sheet was fed through second and third pairs of nip rolls disposed downstream and in tandem with the pair of heated steel nip rolls 24 and 26, each pair of the second and third pairs of nip rolls including a heated steel roll and a resilient back-up roll. This further pressing of the scrim-bearing carbon fiber sheet enhanced the migration of the thermoplastic binding agent from the scrims into the carbon fiber sheet. Following passage through the last of these nip rolls, the sheet was cooled and collected in a roll.

### EXAMPLE 2

Using a method similar to the process of Example 1, a reinforcing sheet was produced comprising a carbon fiber sheet weighing 225 grams/square meter contained between two scrims 18 and 18′, each scrim weighing 8 grams/square meter.

### EXAMPLE 3

Using a method similar to the process of Example 1, one of the scrims 18 or 18′ was replaced with the reinforcing sheet produced in Example 2. The resulting reinforcing sheet, having a carbon fiber weight of 450 grams/square meter thus includes three parallel scrims (an upper scrim, a middle scrim and a lower scrim) with two layers of carbon fibers interleaved between the three scrims, thus providing improved sheet integrity.

### EXAMPLE 4

A reinforcing sheet having a carbon fiber weight of 900 grams/square meter was produced by overlaying a first reinforcing sheet produced in accordance with Example 3 over a second reinforcing sheet produced in accordance with Example 3 and feeding the two reinforcing sheets between the heated nip rolls 24 and 26 to bind the lower scrim of the first reinforcing sheet to the upper scrim of the second reinforcing sheet.

### EXAMPLE 5

Using a process similar to the process of Example 1, a reinforcing sheet was produced comprising a carbon fiber sheet weighing 450 grams/square meter contained between two scrims 18 and 18′, each scrim weighing 8 grams/square meter.

### EXAMPLE 6

Using a process similar to the process of Example 1, the carbon fiber tow of Example 2 was split into two sheets by directing every other fiber, the odd fibers, upwardly over a reel of glass wicking material and directing the even fibers downwardly under the reel of wicking material. A reinforcing sheet was produced in which a glass wicking layer is positioned between two carbon fiber sheets prior to application of the scrims to the first and second.

Thereafter, the odd fibers and even fibers were redirected into contact with opposing surfaces of the glass wicking layer to create a layered sheet and scrims were applied to the first surface and second surface of the layered sheet. The time required for resin wetout of the layered sheet was markedly improved.

### EXAMPLE 7

Under the same conditions as used in Example 2, a carbon fiber sheet was formed in which the tow was separated with a comb just prior to the nip rolls 24 and 26 to define a plurality of individual ribbons, each approximately one inch wide, which were spaced apart from one another by a distance of about 0.04 inch to 0.5 inch. The spaced relationship of the ribbons was then maintained by the bonding of the scrims. The time required for resin wetout of the reinforcing sheet was markedly improved.

### EXAMPLE 8

Under the same conditions as used in Example 2, a decorative fabric consisting of a chopped carbon fiber mat weighing 25 grams/square meter was applied on the top surface of the first scrim 18 to encase the first scrim between the sheet 12 and the decorative layer.

Whereas the present invention has been described in specific terms, one skilled in the art will recognize permissible variations and modifications of the invention which do not depart from the scope of this invention.

We claim:

1. A reinforcing sheet comprising:
a plurality of fiber monofilaments defining a sheet having a first surface and an opposed second surface,
a first scrim bonded to said first surface of said sheet, and
a second scrim bonded to said second surface of said sheet.

2. A reinforcing sheet in accordance with claim 1 wherein said first scrim and said second scrim are wider than said sheet and said first scrim is bonded to said second scrim.

3. A reinforcing sheet in accordance with claim 1 wherein said monofilaments have a high tensile modulus.

4. A reinforcing sheet in accordance with claim 1 wherein said sheet weighs between 100 grams/square meter and 1,000 grams/square meter.

5. A reinforcing sheet in accordance with claim 1 wherein said first scrim and said second scrim comprise yarns selected from a group comprising glass and polyester.

6. A reinforcing sheet in accordance with claim 1 wherein said first scrim and said second scrim each weigh between 5 grams/square meter and 25 grams/square meter.

7. A reinforcing sheet in accordance with claim 1 wherein said first scrim and said second scrim comprise yarns arranged in intersecting patterns and said yarns include a bonding agent for bonding said yarns at intersections in said patterns.

8. A reinforcing sheet in accordance with claim 7 wherein a common bonding agent bonds said yarns at intersections and bonds said scrims to said sheet.

9. A reinforcing sheet in accordance with claim 1 wherein said first scrim and said second scrim are bonded to said first surface and said second surface with a thermoplastic bonding agent.

10. A reinforcing sheet in accordance with claim 9 wherein said thermoplastic bonding agent is selected from a group comprising polyester, polyamide and polyethylene acrylic.

11. A reinforcing sheet in accordance with claim 1 wherein said sheet is separated to define a plurality of spaced-apart ribbons of monofilaments.

12. A reinforcing sheet in accordance with claim 1 wherein said sheet includes sizing in an amount of 0.2 to 5.0 weight percent.

13. A reinforcing sheet in accordance with claim 12 wherein said sizing is selected from a group comprising epoxies, vinylesters, polyurethanes, phenolics, polyesters, and polyamides.

14. A reinforcing sheet in accordance with claim 1 wherein said monofilaments are oriented in a common direction.

15. A reinforcing sheet comprising a plurality of generally parallel fiber sheets bonded between a first scrim and a second scrim.

16. A reinforcing sheet in accordance with claim 15 wherein a scrim is bonded between two parallel fiber sheets.

17. A reinforcing sheet in accordance with claim 15 and further comprising a wicking layer.

18. A reinforcing sheet in accordance with claim 15 and further comprising a decorative layer.

19. A reinforcing sheet in accordance with claim 15 wherein said monofilaments are oriented in a common direction.

20. A method of manufacturing a reinforcing sheet comprising:
defining a sheet having a first surface and an opposed second surface with a plurality of monofilaments;
bonding a first scrim to said first surface of said sheet; and
bonding a second scrim to said second surface of said sheet.

21. A method of manufacturing a reinforcing sheet in accordance with claim 20 wherein each of said first scrim and said second scrim has a weight of about 5 to about 25 grams/square meter.

22. A method of manufacturing a reinforcing sheet in accordance with claim 20 wherein said sheet weighs between 100 grams/square meter and 1,000 grams/square meter.

23. A method of manufacturing a reinforcing sheet in accordance with claim 20 wherein said monofilaments have a high tensile modulus.

24. A method of manufacturing a reinforcing sheet in accordance with claim 20 wherein said first scrim and said second scrim comprise woven yarns bonded at intersections by a bonding agent on said yarns.

25. A method of manufacturing a reinforcing sheet in accordance with claim 20 wherein said first scrim and said second scrim are bonded to one another along edges of said sheet.

26. A method of manufacturing a reinforcing sheet in accordance with claim 20 wherein said sheet is separated into a plurality of spaced-apart ribbons prior to bonding said first scrim and said second scrim to said sheet.

27. A method of manufacturing a reinforcing sheet in accordance with claim 20 wherein said monofilaments are oriented in a common direction.

28. A method of manufacturing a reinforcing sheet in accordance with claim 20 wherein a wicking layer is bonded to said reinforcing sheet.

29. A method of manufacturing a reinforcing sheet in accordance with claim 20 wherein a decorative layer is bonded to said reinforcing sheet.

30. A method of manufacturing a reinforcing sheet comprising:
defining a first sheet having a first surface and an opposed second surface with a plurality of monofilaments;
defining a second sheet having a first surface and an opposed second surface with a plurality of unidirectional monofilaments;
bonding a first scrim to said first surface of said first sheet; and
bonding a second scrim to said second surface of said second sheet; and
bonding said first scrim to said second scrim.

31. A method of manufacturing a reinforcing sheet in accordance with claim 28 wherein a wicking material is inserted between said first sheet and said second sheet prior to bonding said first scrim and said second scrim.

32. A method of manufacturing a reinforcing sheet in accordance with claim 28 wherein a scrim is bonded between said first sheet and said second sheet.

33. A method of manufacturing a reinforcing sheet in accordance with claim 28 wherein said monofilaments are oriented in a common direction.
